(19) United States
(12) Patent Application Publication
(10) Pub. No.: US 2011/0151406 A1
(43) Pub. Date: Jun. 23, 2011

(54) Dental articulating paper forceps

(76) Inventors: Mildred Solano, Marlton, NJ (US); Ronald A. Apalucci, Marlton, NJ (US)

(21) Appl. No.: 12/653,698

(22) Filed: Dec. 17, 2009

(51) Int. Cl. A61C 3/00

(52) U.S. Cl. 433/162

(57) ABSTRACT

Dental forceps for holding dental articulating paper has dual elongated spring arms, moveable toward and away from each other. The spring arms each have a lower handle section, an intermediate section extending from the lower handle section, and an upper section with a cantilevered member extending from the top end of the intermediate section. Clamping support arms extend outward from and perpendicular to the cantilevered member of each of the spring arms. The support arms have jagged surfaces which enhance the paper holding capability of the spring arms. When the spring arms are fully biased away from each other, the support arms are closed and articulating paper is held therebetween. When the lower handle sections of the spring arms are moved together, the support arms open to release the paper.

### BACKGROUND OF THE INVENTION

The present invention is directed to forceps for firmly holding dental articulating paper which is to be positioned and then inserted between a patient's tooth and crown.

There are a wide variety of articulating paper forceps which are employed by dentists to introduce articulating paper into a patient's mouth. One such common forcep utilizes a pair of spring arms which are interconnected to each other at one end and which have clamping elements at their distal ends. The arms are of different length and cross over at approximately their mid-sections. Clamp type members extend from the ends of the arms and are offset therefrom. The spring action of the arms maintains the clamp members in contact with one another. The contact is released to allow insertion of the articulating paper between the clamp members by forcing the ends of the arms together.

However, this and similar configured forceps have inherent handicaps in that they are difficult to maneuver and thus prevents the dental professional from efficiently and easily positioning articulating paper within a patient's mouth. This is especially the case when paper needs to be inserted near the back, more hard to get to molars.

### SUMMARY OF THE INVENTION

It is thus the object of the present invention to provide dental articulating paper forceps which overcome the limitations and disadvantages of prior forceps.

The dental forceps of the present invention constitutes a significant improvement over existing forceps, in that it is conveniently utilized and readily maneuverable within the patient's mouth. Its configuration makes positioning and placement of articulating paper between the interproximal surface of a crown, bridge or dental appliance and a tooth easier and faster, while ensuring less patient discomfort. The forceps also serve to hold the paper more firmly in position.

These and other objectives are accomplished by the present invention, dental forceps for holding dental articulating paper having dual elongated spring arms, moveable toward and away from each other. The spring arms each have a lower handle section, an intermediate section extending from the lower handle section, and an upper section with a cantilevered member extending from the top end of the intermediate section. Clamping support arms extend outward from and perpendicular to the cantilevered member of each of the spring arms. The support arms have jagged surfaces which enhance the paper holding capability of the spring arms. When the spring arms are fully biased away from each other, the support arms are closed and articulating paper is held therebetween. When the lower handle sections of the spring arms are moved together, the support arms open to release the paper.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the forceps of the present invention with the clamping support arms in their closed position.

FIG. 2 is an isometric view of the forceps of the present invention with the clamping support arms in their open position.

FIG. 3 is a close up view of the clamping support members of the present invention.

FIG. 4 is a view of the inner surface of a clamping support arm, taken from FIG. 3.

FIG. 5 depicts the contemplated use of the forceps of the present invention.

FIG. 6 is an elevation view of the forceps of the present invention.

FIG. 7 is an elevation view of an alternative embodiment of the forceps of the present invention.

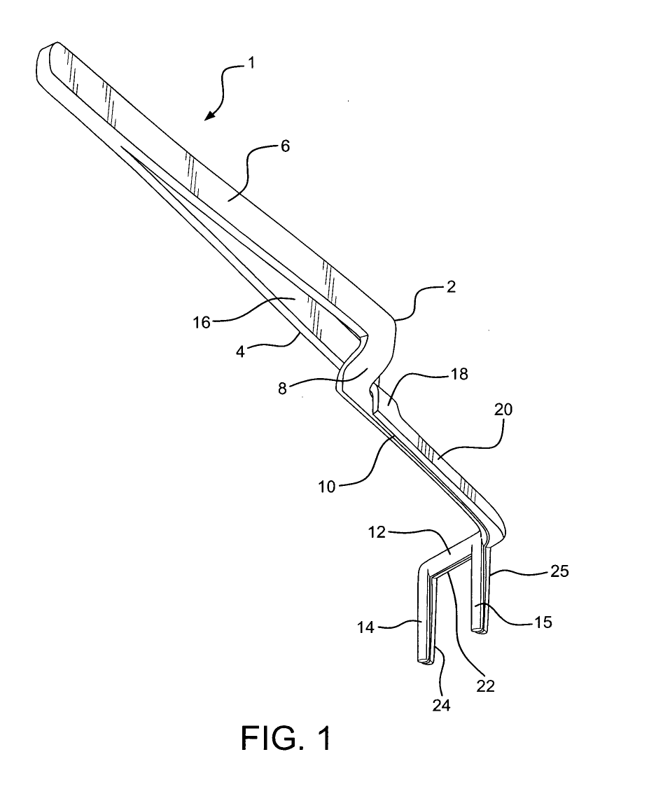

### DETAILED DESCRIPTION OF THE INVENTION

Dental articulating paper forceps 1 comprises opposed spring arms 2 and 4. Spring arm 2 comprises handle section 6, intermediate section 8 located substantially perpendicularly from the handle section, and clamp support section 10 which has right angled cantilevered member 12. Clamping support members 14 and 15 extend perpendicularly out from cantilevered member 12. Spring arm 4 comprises handle section 16, intermediate section 18 located substantially perpendicularly from the handle section, and clamp support section 20 which has right angled cantilevered member 22. Clamping support members 24 and 25 extend perpendicularly out from cantilevered member 22.

Spring arms 2 and 4 are joined together at their respective handle sections 6 and 16 via a tweezer-like configuration, such that they are resiliently spread apart at their upper ends. Spring arm 2 crosses over spring arm 4, such that intermediate sections 8 and 18 and sections 10 and 20 are biased together, such that sections 10 and 20 are generally in adjacent alignment to each other when forceps 1 is in the closed position. In like manner, the resilient, spring-like forces of spring arms 2 and 4 also compel clamping support members 14 and 15 against clamping support members 24 and 25.

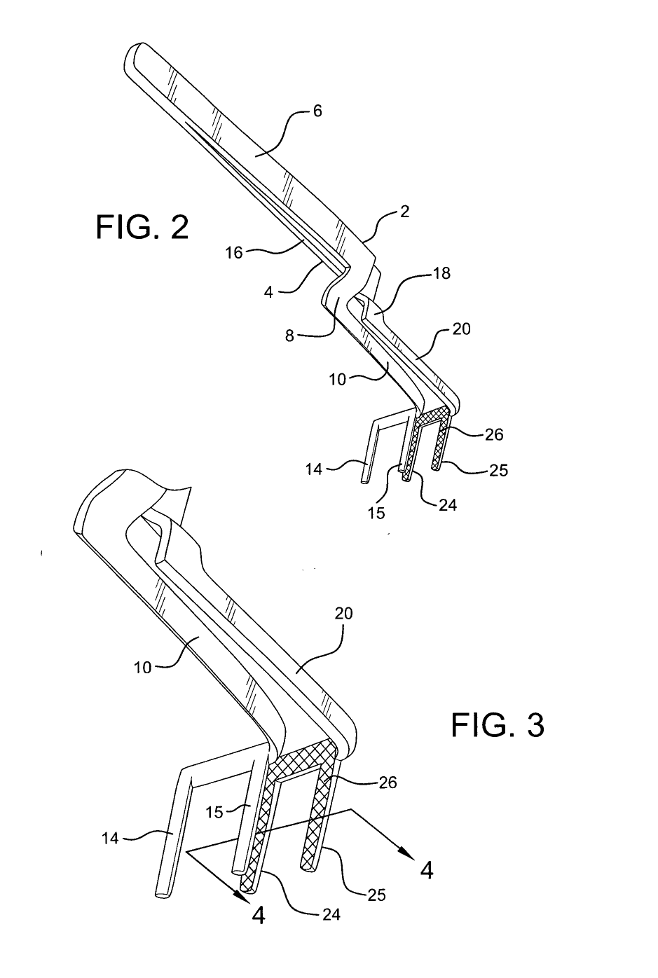

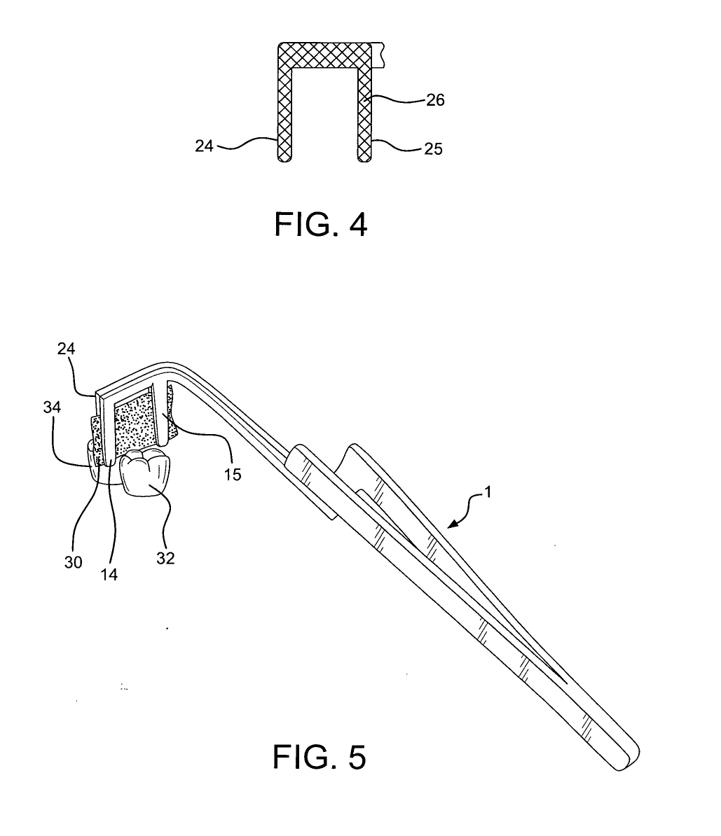

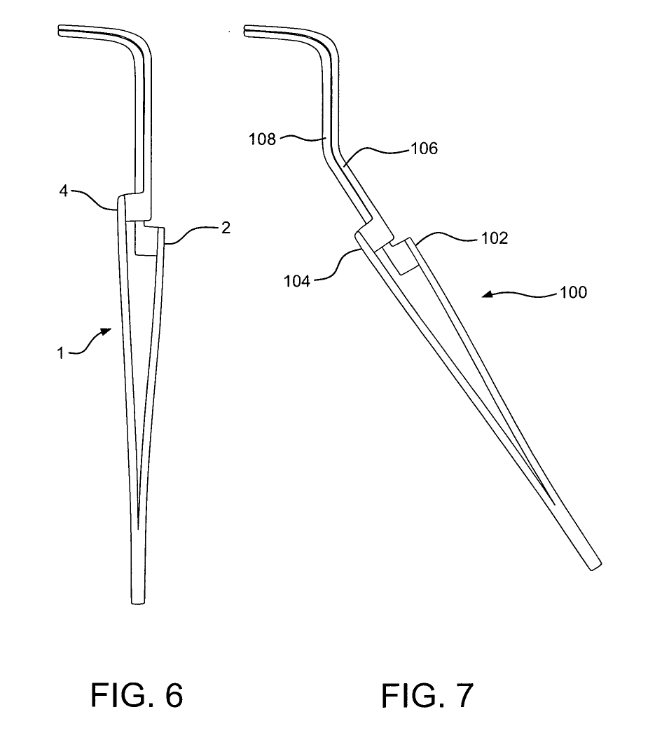

As best seen in FIG. 2, application of manual pushing pressure on the outer sides of handle sections 6 and 16 of spring arms 2 and 4 causes these sections to move together. However, due to the asymmetrical relationship between spring arms 2 and 4, movement of handle sections 6 and 16 towards each other results in intermediate sections 8 and 18 and sections 10 and 20 moving away from each other. When sections 10 and 20 are spread apart, dental articulating paper may be positioned between clamping support members 14 and 15, and 24 and 25. Releasing the pressure on handle sections 6 and 16 results in intermediate sections 8 and 18 and sections 10 and 20 coming together, once again, causing closure of clamping support members 14 and 15, and 24 and 25. Articulating paper located between the clamping support members is thus secured therebetween. Knurled surface projections 26 are provided on the interior surfaces of clamping support members 14, 15, 24 and 25. These projections enhanced the ability of the clamping support members to retain the articulating paper therebetween.

As depicted in FIG. 5, once articulated paper 30 is retained between clamping support members 14 and 15 and 24 and 25, forceps 1 can easily be positioned in the patient's mouth such that the paper is directly over the space between tooth 32 and inserted crown or bridge 34. Forceps 1, firmly holding articulating paper 30, can then be readily inserted adjacent to tooth 32 and crown 34, thus allowing the paper to mark the areas of the crown which need adjustment. After crown 34 has been properly placed and the necessary adjustments done, forceps 1, with paper 30 still being firmly held between clamping support members 14 and 15 and 24 and 25, is removed from the patient's mouth. Pushing lower handle sections 6 and 16 of spring arms 2 and 4, separates clamping support members 14 and 15 from clamping support members 24 and 25, thus releasing articulated paper 30.

FIG. 7 shows an alternate configuration of the invention. In this embodiment forceps 100 has spring arms 102 and 104. Clamp support sections 106 and 108 of the spring arms are obtusely angled providing the dental professional an additional option in positioning articulated paper within a patient's mouth.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A dental forceps for holding dental articulating paper, said forceps comprising:
dual elongated spring arms biased in a direction opposite one another and moveable toward and away from each other, each spring arm comprising:
a handle section;
an intermediate section extending from the handle section;
a clamp support section extending from the intermediate section, said clamp support section having a cantilevered member extending therefrom; and
clamping means extending outward, perpendicular to the cantilevered member, for removeably holding articulating paper, whereby when the spring arms are fully biased away from each other, the clamping means are closed and the paper is held by the clamping means, and when the handle sections of the spring arms are moved toward each other, the clamping means is opened to release the paper.

2. The dental forceps as in claim 1 wherein the clamping means comprises knurled surfaces to enhance its paper holding capability.

3. The dental forceps as in claim 1 wherein the clamping means comprises support arms.

4. The dental forceps as in claim 3 wherein the support arms comprise knurled surfaces to enhance their paper holding capability.

5. The dental forceps as in claim 1 wherein the handle sections of each of the spring arms are joined together.

6. The dental forceps as in claim 1 wherein the clamp support sections are obtusely angled.

7. The dental forceps as in claim 3 whereby when the handle sections of the spring arms move towards each other, the support arms move away from each other to release the paper.

8. The dental forceps as in claim 1 wherein the cantilevered members of each spring arm extend perpendicularly from their respective clamp support sections.
